(19) United States
(12) Patent Application Publication
(10) Pub. No.: US 2024/0181529 A1
(43) Pub. Date: Jun. 6, 2024

(54) Installation for the production of metal powders

(71) Applicant: ArcelorMittal, Luxembourg (LU)

(72) Inventors: Enrique HERRAIZ LALANA, Avilés, Asturias (ES); Udaya Bhaskar KODUKULA, Munster, IN (US)

(21) Appl. No.: 18/287,589

(22) PCT Filed: Apr. 26, 2022
(86) PCT No.: PCT/IB2022/053852

§ 371 Date: Oct. 19, 2023

(30) Foreign Application Priority Data
Apr. 27, 2021 (WO) PCT/IB2021/053456

(51) Int. Cl. B22F 9/08

(52) U.S. Cl. CPC B22F 9/082; B22F 2009/0832; B22F 2009/0876; B22F 2009/0896

(57) ABSTRACT

An installation for the production of metal powders is provided including a gas atomizer comprising an atomization chamber having a top and a bottom, an atomization nozzle, positioned at the top of the chamber, through which liquid metal can flow, a gas sprayer, adjacent to the nozzle, through which gas can be jetted on the liquid metal and an opening at the bottom of the atomization chamber for discharging the metal powder, a double pipe heat exchanger comprising an inner pipe and an outer pipe, the two pipes being concentric, the inner pipe being connected to the opening at the bottom of the atomization chamber and the outer pipe being connected to the gas sprayer of the atomizer.

A corresponding process is also provided.

The present invention relates to an installation for the production of metal powders and in particular for the production by gas atomization of steel powders for additive manufacturing. The present invention also relates to the method for cooling metal particles at the exit of a gas atomizer.

### BACKGROUND

There is an increasing demand for metal powders for additive manufacturing and the manufacturing processes have to be adapted consequently.

### SUMMARY OF THE INVENTION

It is notably known to melt metal material and to pour the molten metal in a tundish connected to an atomizer. The molten metal is forced through a nozzle in a chamber under controlled atmosphere and impinged by jets of gas which atomize it into fine metal droplets. The latter solidify into fine particles which fall at the bottom the chamber and accumulate there until the molten metal has been fully atomized. The powder is then let to cool in the atomizer until it reaches a temperature where it can be in contact with air without oxidizing too quickly. The atomizer is then opened to collect the powder. Such a cooling is a long process which is not compatible with the need for producing large amounts of metal powders.

An aim of the present invention is therefore to remedy the drawbacks of the facilities and processes of the prior art by providing an installation wherein the obtained powder can be efficiently cooled.

Also, as the ratio between the gas flow rate (in m³/h) and the metal flow rate (in Kg/h) is preferably kept between 1 and 5, huge volumes of gas are needed at industrial scale for atomizing the molten metal.

An additional or alternate aim of the present invention is to provide an installation wherein the gas is efficiently used.

For this purpose, a first subject of the present invention consists of an installation for the production of metal powders comprising:
a gas atomizer comprising an atomization chamber having a top and a bottom, an atomization nozzle, positioned at the top of the chamber, through which liquid metal can flow, a gas sprayer, adjacent to the nozzle, through which gas can be jetted on the liquid metal and an opening at the bottom of the atomization chamber for discharging the metal powder,
a double pipe heat exchanger comprising an inner pipe and an outer pipe, the two pipes being concentric, the inner pipe being connected to the opening at the bottom of the atomization chamber and the outer pipe being connected to the gas sprayer of the atomizer.

The installation according to the invention may also have the optional features listed below, considered individually or in combination:
the installation further comprising a grading station,
the inner pipe is a pneumatic transport pipeline,
the inner pipe comprises a transport gas inlet,
the transport gas inlet is positioned adjacent to the opening at the bottom of the atomization chamber,
the inner pipe is connected to the opening at the bottom of the atomization chamber by the first end of the double pipe heat exchanger,
the inner pipe is connected to the entry of the grading station by the second end of the double pipe heat exchanger,
the inner pipe is connected to the exit of the grading station by the first end of the double pipe heat exchanger,
the outer pipe is connected to the gas sprayer by the first end of the double pipe heat exchanger,
the outer pipe is connected to the exit of the grading station by the second end of the double pipe heat exchanger,
the outer pipe is connected to a gas regulator,
the atomizer further comprises a purge in the atomization chamber for purging the particles bed at the bottom of the atomization chamber,
the outer pipe is connected to the purge by the first end of the double pipe heat exchanger,
the purge is connected to the transport gas inlet of the inner pipe,
the atomizer further comprises a gas extractor connected to the atomization chamber,
the gas extractor is connected to the gas sprayer,
the gas extractor is connected to the outer pipe by the second end of the double pipe heat exchanger.

A second subject of the invention consists of a process for cooling metal particles at the exit of a gas atomizer, wherein the gas to be used for the atomization is first contacted with the metal particles discharged from the atomizer in a double pipe heat exchanger comprising an inner pipe and an outer pipe, the two pipes being concentric.

The process according to the invention may also have the optional features listed below, considered individually or in combination:
the gas to be used for the atomization circulates one way in the outer pipe while the metal particles discharged from the atomizer circulate the other way in the inner pipe,
the gas to be used for the atomization is gas recycled from a grading station, which is part of an installation for the production of metal powders comprising the gas atomizer and the double pipe heat exchanger,
the gas to be used for the atomization is gas recycled from the gas atomizer,
the gas used to transport the metal particles in the inner pipe is gas recycled from a grading station, which is part of an installation for the production of metal powders comprising the gas atomizer and the double pipe heat exchanger,
the gas used to transport the metal particles in the inner pipe is gas recycled from the gas atomizer.

As it is apparent, the invention is based on a double pipe heat exchanger in which the metal particles discharged from the atomizer are cooled down by the gas to be used for the atomization. This way, the particles are efficiently cooled down during their transport to the next equipment of the installation while, in the meantime, this gas is heated so that heated gas can be sprayed on the molten metal in the atomization chamber. Consequently, the particles are cool enough for their handling in the next equipment, which can be for example a grading station. They are also cool enough to be handled outside of a protective atmosphere since they will not oxidize. Using heated gas for the atomization is also beneficial. The heated gas reduces the cooling rate, giving more time to the particles to solidify. Consequently, the surface tension can play its role on a longer period to bring the particles to more rounded particles or even perfect spheres. Also, the gas being heated, the gas speed at the exit of the gas sprayer is higher. The gas jet atomizes more efficiently the molten metal which brings smaller particles. The particle size distribution is shifted to a smaller range.

Other characteristics and advantages of the invention will be described in greater detail in the following description.

### BRIEF DESCRIPTION OF THE DRAWINGS

The invention will be better understood by reading the following description, which is provided purely for purposes of explanation and is in no way intended to be restrictive, with reference to:

FIG. 1, which is an installation according to the invention,

FIG. 2, which is an installation according to a first variant of the invention,

FIG. 3, which is an installation according to a second variant of the invention,

FIG. 4, which is an installation according to a third variant of the invention,

FIG. 5, which is an installation according to a fourth variant of the invention.

### DETAILED DESCRIPTION

It should be noted that the terms “lower”, “beneath”, “inward”, “inwards”, “outward”, “outwards”, “upstream”, “downstream”, . . . as used in this application refer to the positions and orientations of the different constituent elements of the installation when the latter is installed in a plant.

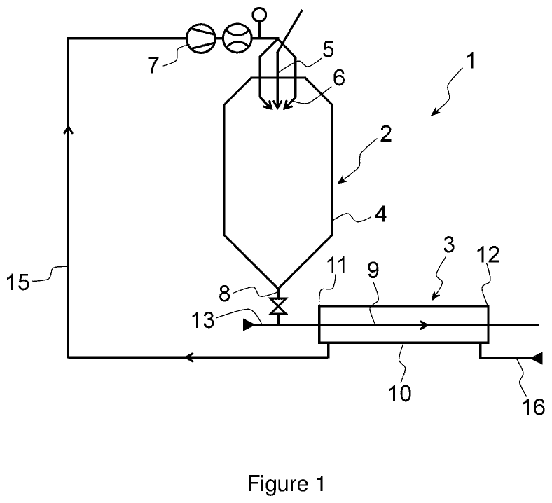

With reference to FIG. 1, the installation 1 for the production of metal powders is mainly composed of a gas atomizer 2 and a double pipe heat exchanger 3.

A gas atomizer 2 is a device designed for atomizing a stream of liquid metal into fine metal droplets by impinging the stream with a high velocity gas. The gas atomizer 2 is mainly composed of an atomization chamber 4, which is closed and maintained under protective atmosphere. The chamber has an upper section, a lower section, a top and a bottom.

The upper section of the atomization chamber comprises an orifice, the nozzle 5, usually positioned at the center of the chamber top, through which the molten metal stream is forced. The nozzle is adjacent to a gas sprayer 6 for jetting a gas at high speed on the stream of liquid metal. The gas sprayer is preferably an annular slot, placed coaxially with the nozzle, through which pressurized gas flows. The gas sprayer is preferably coupled to a gas regulator 7 to control the flow and/or the pressure of the gas before jetting it. The gas regulator can be a compressor, a fan, a pump, a pipe section reduction or any suitable equipment.

The lower section of the atomization chamber is mainly a receptacle for collecting the metal particles falling from the upper section of the chamber. It is usually designed to facilitate the powder collection and powder discharge through an opening 8 positioned at the bottom of the chamber. It is thus usually in the form of an inverted cone or an inverted frustoconical shape.

As mentioned above, the double pipe heat exchanger is designed to cool the metal particles discharged from the atomizer during their transport while the gas to be used for the atomization is heated. To that effect, the double pipe heat exchanger 3 comprises an inner pipe 9 for the transport of the metal powder discharged from the atomization chamber and an outer pipe 10 for the transport of atomization gas. These two pipes are concentric. The fact that the pipes are concentric provides an efficient heat transfer between the metal powder and the atomization gas.

The double pipe heat exchanger comprises a first end 11 and a second end 12. The inner pipe and the outer pipe have respectively a first end located on the side of the first end of the heat exchanger and a second end located on the side of the second end of the heat exchanger.

At one of its ends, the inner pipe 9 is connected to the opening 8 at the bottom of the atomization chamber. The way the connection and opening are designed is not particularly limited in the context of the invention. In the case where the atomizer is running continuously, the opening is designed so that the metal powder can be discharged continuously from the atomizer without disrupting the atomization. The opening can be, for example a control valve or a rotary valve.

The inner pipe can be directly connected to the atomization chamber. In that case, the metal particles directly flow from the atomization chamber into the inner pipe. Alternatively, the inner pipe can be indirectly connected to the atomization chamber. In that case, the metal particles pass through other piece(s) of equipment and/or chamber(s) of the atomizer when been discharged from the atomizer in the inner pipe.

The inner pipe 9 is preferably a pneumatic transport pipeline. The transport of the metal powder is thus facilitated. Pneumatic conveying is a way to transport powder in a dilute phase. The powder is diluted by a gas and is transported in the form of a cloud in the inner pipe. The pneumatic conveying can be in dense phase or lean phase depending on the ratio of metal powder (in Kg) to gas (in Kg).

According to one variant of the invention, the transport in the inner pipe is provided by blowing the gas with an overpressure at the beginning of the inner pipe, i.e. on the side of the opening 8. Accordingly, the inner pipe comprises a transport gas inlet 13. The latter can be designed to let fresh gas in the inner pipe. Alternatively, or in combination, the transport gas inlet can be designed to inject recirculated gas in the inner pipe. In that case, the transport gas inlet is connected to other gas pipes and/or other gas regulators of the installation. Examples of such gas recirculation are described later. Whatever the design of the transport gas inlet, it is preferably coupled to a gas regulator to control the flow and/or the pressure of gas entering the inner pipe. The gas regulator can be a compressor, a fan, a pump, a pipe section reduction or any suitable equipment.

In another variant of the invention, the transport in the inner pipe is provided by sucking gas from the end of the inner pipe to create a vacuum. In that case, the inner pipe comprises a gas outlet at the end of the inner pipe, i.e. on the opposite side of the opening 8. The gas outlet is connected to a blower or a vacuum pump.

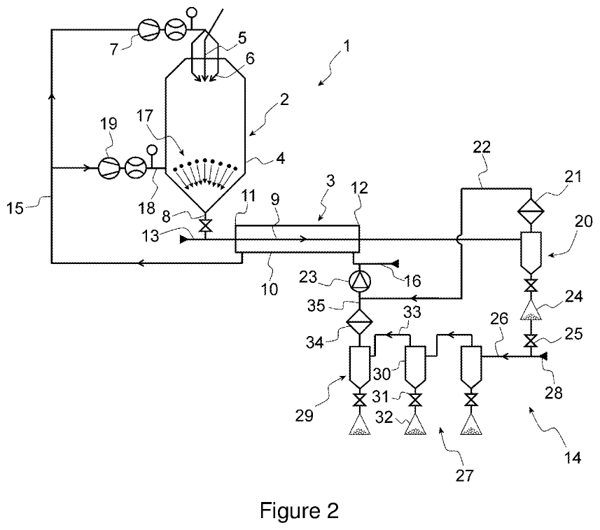

On the side of the inner pipe opposite to the opening 8, the inner pipe is preferably connected to the equipment to be used in the next step of the process. The inner pipe is preferably connected to a grading station 14 (see, e.g., FIGS. 2 to 5).

At one of its ends, the outer pipe 10 is connected to the gas sprayer 6 of the atomizer. This connection can be done through a gas conduit 15, which transports the gas heated in the heat exchanger to the gas sprayer. A compressor can be positioned between the outer pipe and the gas sprayer in case the gas has to be pressurized or further pressurized before being jetted on the stream of molten metal.

At its other end, the outer pipe 10 comprises a cooling gas inlet 16. The latter can be designed to let fresh gas in the outer pipe. Alternatively, or in combination, the cooling gas inlet can be designed to inject recirculated gas in the outer pipe. In that case, the cooling gas inlet is connected to other gas pipes and/or other compressors of the installation. Examples of such gas recirculation are described later. Whatever the design of the cooling gas inlet, it is preferably coupled to a gas regulator to control the flow and/or the pressure of gas entering the outer pipe. The gas regulator can be a compressor, a fan, a pump, a pipe section reduction or any suitable equipment.

The respective and relative diameters of the inner and outer pipes are adjusted to the dimensions of the installation. In particular, they are adjusted so that the gas circulating in the outer pipe 10 cools the metal particles circulating in the inner pipe 9 at the desired temperature before they are discharged in the grading station 14. Preferably, in the meantime, the gas circulating in the outer pipe 10 is heated at the temperature desired for the atomization. The person skilled in the art can easily dimension the inner and outer pipes knowing the desired temperatures and the flow of particles discharged from the atomizer.

For efficiency reasons, the gas and the metal particles are most preferably circulating at counter-current flow. Accordingly, the inner pipe 9 is connected to the opening 8 at the bottom of the atomization chamber by the first end of the heat exchanger 3 while the outer pipe 10 is connected to the gas sprayer 6 of the atomizer by the same end of the heat exchanger.

In particular, the transport gas inlet 13 of the inner pipe is positioned adjacent to the opening 8 of the atomizer at the first end of the heat exchanger 3 while the cooling gas inlet 16 of the outer pipe is positioned at the second end of the heat exchanger. In other words, the transport gas inlet and the cooling gas inlet are at opposite ends of the heat exchanger.

With reference to FIG. 2, a first variant of the installation is described. This variant differs from the one illustrated on FIG. 1 in that the gas is recirculated and in that the atomizer further comprises a purge 17 for facilitating the discharge of the powder from the atomizer.

The purge 17 preferably comprises a plurality of purge nozzles positioned in the lower section of the atomizer. In particular, they are above the part of the atomizer where the metal powder accumulates. The purge nozzles are designed so that gas can flow along the side walls of the atomizer and push the metal powder towards the opening 8 at the bottom of the atomizer. The purge nozzles can be part of a radial piping system positioned along the periphery of the chamber at a given distance from the bottom of the chamber. The purge nozzles can be part of a plurality of radial piping systems positioned along the periphery of the chamber at different distances from the bottom of the chamber The purge nozzles are coupled to an ancillary gas inlet 18. The latter can be designed to let fresh gas in the purge. Alternatively, or in combination, the ancillary gas inlet can be designed to inject recirculated gas in the purge. In that case, the ancillary gas inlet is connected to other gas pipes and/or other compressors of the installation. In the present example, the ancillary gas inlet 18 is connected to the outer pipe 10 of the heat exchanger 3. In particular, it is connected to the gas conduit 15 connecting the outer pipe to the gas sprayer. Whatever the design of the ancillary gas inlet, it is preferably coupled to a gas regulator to control the flow and/or the pressure of gas entering the purge. The gas regulator can be a compressor, a fan, a pump, a pipe section reduction or any suitable equipment.

The purge 17 can be coupled to a sensor to sense and control the gas pressure for efficient discharge of the metal powder through the opening while maintaining the possible pressure difference between the atomizer and the inner pipe of the heat exchanger.

In the variant illustrated on FIG. 2, the gas used for atomization and transport is also recirculated. In particular, the gas used for transport and which is also used in the grading station 14 is re-injected in the outer pipe 10 of the heat exchanger.

As illustrated on FIG. 2, the second end of the outer pipe of the heat exchanger is connected to the grading station 14, and in particular to a first separator 20 which forms the first stage of the grading station. The first separator can be a cyclone. In the first separator, a lower powder fraction, e.g. a powder fraction below 20 μm, is separated from a higher powder fraction, e.g. a powder fraction above 20 μm. The lower powder fraction passes through a first filter 21 along with most of the gas. The filter can be for example a bag filter or an electrostatic filter. The latter is preferred to withstand temperatures above 150° C. and/or to avoid the bag replacements. The gas exiting the first filter is recirculated. In particular, it is re-injected in the outer pipe 10 of the heat exchanger. The first filter 21 is thus connected to the cooling gas inlet 16 of the outer pipe, for example through a filtered gas conduit 22. In particular, it is connected to the gas regulator 23 coupled to the cooling gas inlet. The gas coming from the first filter can have cooled down sufficiently, while passing through the cyclone, the filter and the filtered gas conduit, to be directly re-injected in the outer pipe. If it has not been cooled enough, a heat exchanger can be added between the filter and the outer pipe, in particular on the filtered gas conduit.

The higher powder fraction, e.g. the fraction above 20 μm, is preferably collected in a first collector 24. The first collector preferably comprises a bottom opening valve 25, like a butterfly valve, to discharge the powder. The discharge is preferably done in a conveyor 26 connected to a classification system 27, which forms the second stage of the grading station.

The conveyor can comprise a conveyor gas inlet 28. The latter can be designed to let fresh gas in the conveyor. Alternatively, or in combination, the conveyor gas inlet can be designed to inject recirculated gas in the conveyor. In that case, the conveyor gas inlet is connected to other gas pipes and/or other compressors of the installation. Whatever the design of the conveyor gas inlet, it is preferably coupled to a gas regulator to control the flow and/or the pressure of gas entering the conveyor. The gas regulator can be a compressor, a fan, a pump, a pipe section reduction or any suitable equipment.

The classification system 27 comprises a series of classifiers or sieves. Each classifier 29 comprises a separation chamber 30, a bottom opening valve 31, a collector 32 and a gas exit 33. The features of the separation chamber are adapted case by case to collect the desired fraction of powder. The separation chambers can be designed to collect sequentially some of the fractions or grades of interest. Examples of grades are 20-60 μm, 60-150 μm and 150-250 μm.

The powder coming from the conveyor 26 passes sequentially through each classifier 29 of the classification system. A fraction of the powder is sieved and collected in the corresponding collector 32 and the remaining part of the powder is transported to the next classifier.

At the exit of the classification system 27, the gas passes through a second filter 34. The filter can be for example a bag filter or an electrostatic filter. The latter is preferred to withstand temperatures above 150° C. and/or to avoid the bag replacements. The gas exiting the second filter is recirculated. In particular, it is re-injected in the outer pipe 10 of the double pipe heat exchanger. The exit of the grading station is thus connected to the outer pipe. In particular, the second filter 34 is connected to the cooling gas inlet 16 of the outer pipe, for example through a second filtered gas conduit 35. In particular, it is connected to the gas regulator 23 coupled to the cooling gas inlet 16. The gas coming from the second filter can have cooled down sufficiently, while passing through the classification system, to be directly re-injected in the outer pipe. If it has not been cooled enough, a heat exchanger can be added between the second filter and the outer pipe, in particular on the second filtered gas conduit.

Optionally, the gas from the different fractions obtained in the classification system is also captured and recirculated in the outer pipe.

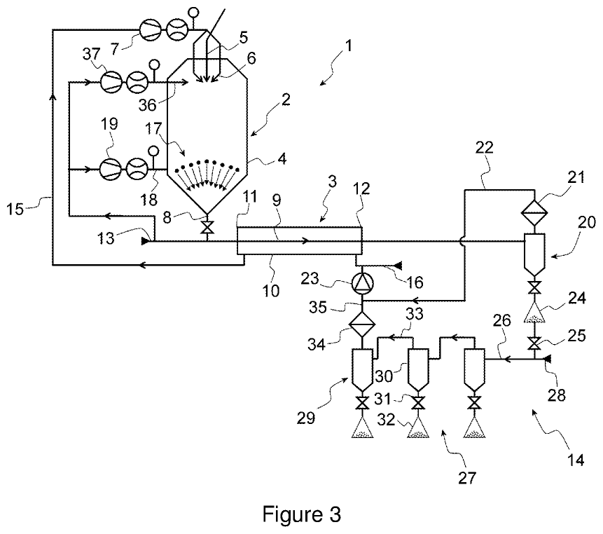

With reference to FIG. 3, a second variant of the installation is described. This variant differs from the one illustrated on FIG. 2 in that the ancillary gas inlet 18 of the purge 17 is connected to the same gas source than the transport gas inlet 13 of the inner pipe. As the purge is preferably done with low pressure gas, similarly to the transport in the inner pipe, this connection is more efficient.

In this variant, the atomizer further comprises a secondary gas sprayer 36 in its upper section. This secondary gas sprayer is designed to inject gas in the vicinity of the nozzle to maintain it clean. As low pressure gas is preferably used for the secondary gas sprayer, the latter is preferably connected to the same gas source than the transport gas inlet 13 of the inner pipe, similarly to the ancillary gas inlet 18. The secondary gas sprayer is preferably coupled to a gas regulator 37 to control the flow and/or the pressure of gas entering the chamber. The gas regulator can be a compressor, a fan, a pump, a pipe section reduction or any suitable equipment.

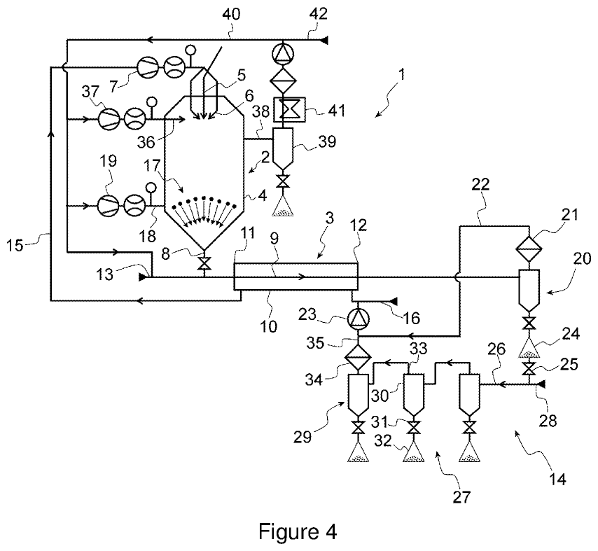

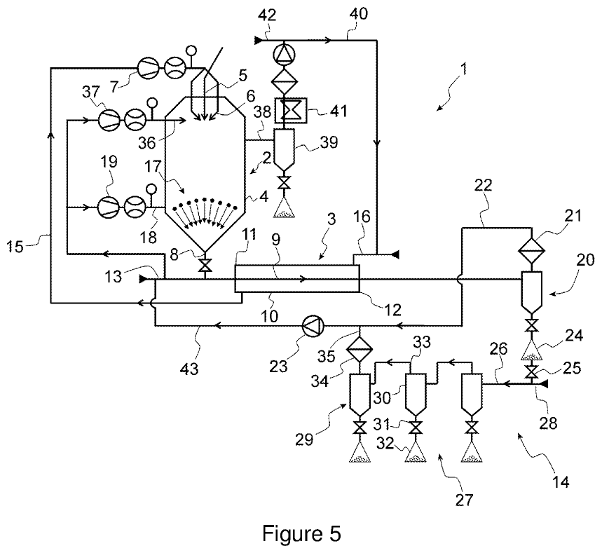

With reference to FIGS. 4 and 5, the atomizer can further comprise a gas extractor 38 to compensate for the gas injection through the gas sprayer and possibly through the purge. The gas extractor is preferably located in the upper section of the chamber so that it doesn't interfere with the metal powder at the bottom of the chamber. The gas extractor can be in the form of one pipe or a plurality of pipes connected on one side to the chamber and on the other side to dedusting means 39. The dedusting means remove the finest particles from the extracted gas. They can comprise an electro-filter, a bag filter or a cyclone separator. Cyclone separator is preferred because it has relatively low pressure drops and it has no moving parts.

Preferably the gas extractor 38 is designed so that the gas injected in the chamber and extracted through the gas extractor can be recirculated. Consequently, the gas consumption is minimized. Accordingly, the gas extractor is preferably connected to other parts of the installation, such as the gas sprayer, the purge, the secondary gas sprayer, the cooling gas inlet of the outer pipe of the heat exchanger, the transport gas inlet of the inner pipe or a combination thereof. The connection can be in the form of an extracted gas conduit 40. In particular, the dedusting means 39 connected on one side to the chamber can be connected on the other side to the gas regulator 7 coupled to the gas sprayer 6, or to the gas regulator 19 coupled to the ancillary gas inlet 18, or to the gas regulator 37 coupled to the secondary gas sprayer 36 or to the gas regulator 23 coupled to the cooling gas inlet 16 or to the gas regulator coupled to the transport gas inlet 13 or to a combination thereof. Filters can also be added to further clean the gas to be recirculated.

The extracted gas conduit 40 can comprise a heat exchanger 41. Consequently, the gas can be cooled down to the temperature at which it has to be re-used in case the heat losses in the dedusting means 39 and in the connection are not enough.

The extracted gas conduit may also comprise a gas inlet 42 in case some fresh gas has to be introduced in the system, notably to compensate gas losses.

In a third variant illustrated on FIG. 4, the extracted gas conduit 40 is connected to the gas regulator 37 coupled to the secondary gas sprayer 36 and to the gas regulator 19 coupled to the ancillary gas inlet 18.

In the third variant illustrated on FIG. 4, the extracted gas conduit 40 is further connected to the transport gas inlet 13 of the inner pipe 9 of the double pipe heat exchanger 3. Consequently, the gas extracted from the chamber can be used to transport the metal powder in the inner pipe.

In a fourth variant illustrated on FIG. 5, the extracted gas conduit 40 is connected to the outer pipe 10 of the double pipe heat exchanger and, in particular, to the cooling gas inlet 16 of the outer pipe. Consequently, the gas extracted from the chamber can be used to cool the metal powder in the inner pipe.

The fourth variant illustrated on FIG. 5 further differs from the previous variants in that the filtered gas conduit 22 coming from the first filter 21 of the grading station 14 and the second filtered gas conduit 35 exiting the grading station are connected to the transport gas inlet 13 of the inner pipe 9 of the double pipe heat exchanger. The connection can be in the form of a third filtered gas conduit 43. Consequently, the gas coming from the grading station and which has cooled down while passing through the grading station can be used to transport the metal powder in the inner pipe. If the gas has not been cooled enough, a heat exchanger can be added between the grading station and the inner pipe, in particular on the third filtered gas conduit.

Other designs of the gas recirculation are of course possible.

From a process perspective, the cooling of powder discharged from the atomizer 2 is made possible thanks to a process wherein the gas to be used for the atomization is first contacted with the metal particles discharged from the atomizer in a double pipe heat exchanger 3.

The metal to be atomized can be notably steel, aluminum, copper, nickel, zinc, iron, alloys. Steel includes notably carbon steels, alloyed steels and stainless steels.

The metal can be provided to the atomizer in solid state and melted in a tundish connected to the atomizer through the nozzle 5. It can also be melted at a previous step and poured in the tundish.

According to one variant of the invention, the molten metal to be atomized is steel obtained through a blast furnace route. In that case, pig iron is tapped from a blast furnace and transported to a converter (or BOF for Basic Oxygen Furnace), optionally after having been sent to a hot metal desulfurization station. The molten iron is refined in the converter to form molten steel. The molten steel from the converter is then tapped from the converter to a recuperation ladle and preferably transferred to a ladle metallurgy furnace (LMF). The molten steel can thus be refined in the LMF notably through de-oxidation and a primary alloying of the molten steel can be done by adding ferroalloys or silicide alloys or nitride alloys or pure metals or a mixture thereof. In certain cases where demanding powder compositions have to be produced, the molten steel can be also treated in a vacuum tank degasser (VTD), in a vacuum oxygen decarburization (VOD) vessel or in a vacuum arc degasser (VAD). These equipment allow for further limiting notably the hydrogen, nitrogen, the sulphur and/or carbon contents.

The refined molten steel is then poured in a plurality of induction furnaces. Each induction furnace can be operated independently of the other induction furnaces. It can notably be shut down for maintenance or repair while the other induction furnaces are still running. It can also be fed with ferroalloys, scrap, Direct Reduced Iron (DRI), silicide alloys, nitride alloys or pure elements in quantities which differ from one induction furnace to the others.

The number of induction furnaces is adapted to the flow of molten steel coming from the converter or refined molten steel coming from the ladle metallurgy furnace and/or to the desired flow of steel powder at the bottom of the atomizers.

In each induction furnace, alloying of the molten steel is be done by adding ferroalloys or silicide alloys or nitride alloys or pure metals or a mixture thereof to adjust the steel composition to the composition of the desired steel powder.

Then, for each induction furnace, the molten steel at the desired composition is poured in a dedicated reservoir connected to at least one gas atomizer. By “dedicated” it is meant that the reservoir is paired with a given induction furnace. That said, a plurality of reservoirs can be dedicated to one given induction furnace. For the sake of clarity, each induction furnace has its own production stream with at least one reservoir connected to at least one gas atomizer. With such parallel and independent production streams, the process for producing the steel powders is versatile and can be easily made continuous.

The reservoir is mainly a storage tank capable of being atmospherically controlled, capable of heating the molten steel and capable of being pressurized.

The atmosphere in each of the dedicated reservoirs is preferably Argon, Nitrogen or a mixture thereof to avoid the oxidation of the molten steel.

The steel composition poured in each reservoir is heated above its liquidus temperature and maintain at this temperature Thanks to this overheating, the clogging of the atomizer nozzle is prevented. Also, the decrease in viscosity of the melted composition helps obtaining a powder with a high sphericity without satellites, with a proper particle size distribution.

Finally, when a dedicated reservoir is pressurized, the molten steel can flow from the reservoir to at least one of the gas atomizers connected to the reservoir.

According to another variant of the invention, the metal to be atomized is steel obtained through an electric arc furnace route. In that case, raw materials such as scraps, metal minerals and/or metal powders are fed into an electric arc furnace (EAF) and melted into heated liquid metal at a controlled temperature with impurities and inclusions removed as a separate liquid slag layer. The heated liquid metal is removed from the EAF into a ladle, preferably into a passively heatable ladle and moved to a refining station where it is preferably placed in a inductively heated refining holding vessel. There, a refining step, such as a vacuum oxygen decarburization is performed to remove carbon, hydrogen, oxygen, nitrogen and other undesirable impurities from the liquid metal. The ladle with the refined liquid metal can then be transferred above a closed chamber under controlled vacuum and inert atmosphere and containing the heated tundish of an atomizer. The ladle is connected to a feeding conduit and the heated tundish is then fed in refined liquid metal through the feeding conduit.

Alternatively, the ladle with the refined liquid metal is transferred from the refining station to another inductively heated atomizing holder vessel located at the door of an atomizer station containing a pouring area under controlled vacuum and inert atmosphere with the heated tundish of a gas atomizer. The inductively heated atomizing holder vessel is then introduced into a receiving area where the vacuum and atmosphere are adjusted to the one of the pouring area. Then, the vessel is introduced into the pouring area and the liquid metal is poured into the heated tundish at a controlled rate and atomized with the atomizer.

In both variants, the molten metal is maintained at the atomization temperature in the tundish until it is forced through the nozzle 5 in the chamber 4 under controlled atmosphere and impinged by jets of gas which atomize it into fine metal droplets.

The metal powder formed in the chamber of the atomization is discharged from the atomizer in the inner pipe 9 of the double pipe heat exchanger 3, preferably by purging the chamber. In the inner pipe, the metal powder is transported to the grading station and simultaneously cooled. The pressure in the inner pipe is preferably up to 5 bard, more preferably comprised between 3 and 5 bar.

The gas circulation in the outer pipe 10 of the heat exchanger 3 is preferably adjusted so that the metal powder reaching the exit of the inner pipe, or the entry of the grading station, has been cooled down below 150° C. Consequently, usual sieving equipment can be used by opposition to high temperature resistant equipment. The pressure in the outer pipe is preferably comprised between 20 and 20 bar. Preferably the gas in the outer pipe and the metal particles in the inner pipe are circulating at counter-current flow.

The gas used to transport the powder in the double pipe heat exchanger is preferably used also during the sieving of the powder. At the end of the sieving step, the gas is preferably re-injected in the outer pipe 10 of the double pipe heat exchanger to cool the metal powder transported in the inner pipe 9. Alternatively, the gas is re-injected in the inner pipe 9 of the heat exchanger to transport the metal powder.

The gas injected in the chamber is preferably at least partially extracted from the chamber. It is then dedusted and can be re-used in the installation. It can be re-used for jetting the stream of molten metal, for purging the chamber, for cleaning the nozzle, for cooling the metal powder in the double pipe heat exchanger or for transporting the metal powder in the double pipe heat exchanger.

What is claimed is:

1-23. (canceled)

24. An installation for the production of metal powders, the installation comprising:
a gas atomizer including: an atomization chamber having a top and a bottom; an atomization nozzle positioned at the top of the atomization chamber, liquid metal flowable through the atomization nozzle; a gas sprayer adjacent to the atomization nozzle, gas jettable through the gas sprayer on the liquid metal; and an opening at the bottom of the atomization chamber for discharging the metal powder; and
a double pipe heat exchanger including an inner pipe and an outer pipe, the inner and outer pipes being concentric, the inner pipe being connected to the opening at the bottom of the atomization chamber and the outer pipe being connected to the gas sprayer of the gas atomizer.

25. The installation as recited in claim 24 further comprising a grading station.

26. The installation as recited in claim 24 wherein the inner pipe is a pneumatic transport pipeline.

27. The installation as recited in claim 24 wherein the inner pipe includes a transport gas inlet.

28. The installation as recited in claim 27 wherein the transport gas inlet is positioned adjacent to the opening at the bottom of the atomization chamber.

29. The installation as recited in claim 24 wherein the inner pipe is connected to the opening at the bottom of the atomization chamber by the first end of the double pipe heat exchanger.

30. The installation as recited in claim 25 wherein the inner pipe is connected to an entry of the grading station by a second end of the double pipe heat exchanger.

31. The installation as recited in claim 25 wherein the inner pipe is connected to an exit of the grading station by a first end of the double pipe heat exchanger.

32. The installation as recited in claim 24 wherein the outer pipe is connected to the gas sprayer by a first end of the double pipe heat exchanger.

33. The installation as recited in claim 25 wherein the outer pipe is connected to an exit of the grading station by a second end of the double pipe heat exchanger.

34. The installation as recited in claim 24 wherein the outer pipe is connected to a gas regulator.

35. The installation as recited in claim 24 wherein the gas atomizer further includes a purge in the atomization chamber for purging the particles bed at the bottom of the atomization chamber.

36. The installation as recited in claim 35 wherein the outer pipe is connected to the purge by a first end of the double pipe heat exchanger.

37. The installation as recited in claim 35 wherein the purge is connected to a transport gas inlet of the inner pipe.

38. The installation as recited in claim 24 wherein the atomizer further includes a gas extractor connected to the atomization chamber.

39. The installation as recited in claim 38 wherein the gas extractor is connected to the gas sprayer.

40. The installation as recited in claim 38 wherein the gas extractor is connected to the outer pipe by a second end of the double pipe heat exchanger.

41. A process for cooling metal particles at the exit of a gas atomizer, the process comprising:
first contacting gas to be used for the atomization with metal particles discharged from the gas atomizer in a double pipe heat exchanger including an inner pipe and an outer pipe, the first and second pipes being concentric.

42. The process as recited in claim 41 wherein the gas to be used for the atomization circulates one way in the outer pipe while the metal particles discharged from the atomizer circulate the other way in the inner pipe.

43. The process as recited in claim 41 wherein the gas to be used for the atomization is gas recycled from a grading station, the grading station being part of an installation for the production of metal powders including the gas atomizer and the double pipe heat exchanger.

44. The process as recited in claim 41 wherein the gas to be used for the atomization is gas recycled from the gas atomizer.

45. The process as recited in claim 41 wherein the gas used to transport the metal particles in the inner pipe is gas recycled from a grading station, the grading station being part of an installation for the production of metal powders including the gas atomizer and the double pipe heat exchanger.

46. The process as recited in claim 41 wherein the gas used to transport the metal particles in the inner pipe is gas recycled from the gas atomizer.
